(19) United States
(12) Patent Application Publication
(10) Pub. No.: US 2006/0168560 A1
(43) Pub. Date: Jul. 27, 2006

(54) Report generating systems and methods

(76) Inventor: Sanjay Kumar Pandey, Uttar Pradesh (IN)

Correspondence Address: MICHAEL BEST & FRIEDRICH, LLP, 100 E WISCONSIN AVENUE, MILWAUKEE, WI, 53202, US

(21) Appl. No.: 11/043,556

(22) Filed: Jan. 26, 2005

(51) Int. Cl. G06F 9/44

(52) U.S. Cl. 717/106

(57) ABSTRACT

Methods and systems for producing report-generating program code. A method can include obtaining an indication as to a source of data to be included in a report generated by the execution of the report-generating program code; retrieving data from the source; obtaining formatting instructions for the data to be included in the report-generating program code; and producing the report-generating program code based on the data and the formatting instructions.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Writing a program to generate a report can be a time consuming activity in almost all projects. Normally, a programmer spends extensive amounts of time coding, testing, and re-testing a report program. Often, the programmer may not find all of the errors or mistakes in a program. The programmer may also repeatedly include common errors in a report program, such as forgetting to initialize a record or forgetting to handle a “no input” record condition.

### SUMMARY OF THE INVENTION

Conventional report writing tools often provide report programming assistance. However, conventional report generating tools often only generate the executable program code for the report program and do not provide the program code for a programmer to review and/or modify.

The present invention relates to methods and systems for automatically generating a report based on user input. In particular, embodiments of the invention relate to generating program code (i.e., “instructions”) that when executed generate a report based on data and formats provided by a user.

Some embodiments of the invention therefore provide a method of producing report-generating program code. The method can include obtaining an indication as to a source of data to be included in a report generated by the execution of the report-generating program code; retrieving data from the source; obtaining formatting instructions for the data to be included in the report-generating program code; and producing the report-generating program code based on the data and the formatting instructions.

Another embodiment provides a system for producing report-generating program code. The system can include interfacing means for obtaining an indication as to a source of data to be included in the report-generating program code and for obtaining formatting instructions for the data to be included in the report-generating program code. The system can include retrieving means for retrieving the data from the source and producing means for producing the report-generating program code.

Additional embodiments provide a computer readable medium containing instructions for producing report-generating program code. The instructions can include obtaining an indication as to a source of data to be included in the report-generating program code; retrieving data from the source; obtaining formatting instructions for the data to be included in the report-generating program code; and producing the report-generating program code based on the data and the formatting instructions.

### BRIEF DESCRIPTION OF THE DRAWINGS

FIG. 1 is a schematic illustration of a report generating system according to one embodiment of the invention.

FIG. 2 is a flow chart illustrating a method of producing report-generating program code according to one embodiment of the invention.

FIGS. 3-27 illustrate screen shots related to the steps of the method of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

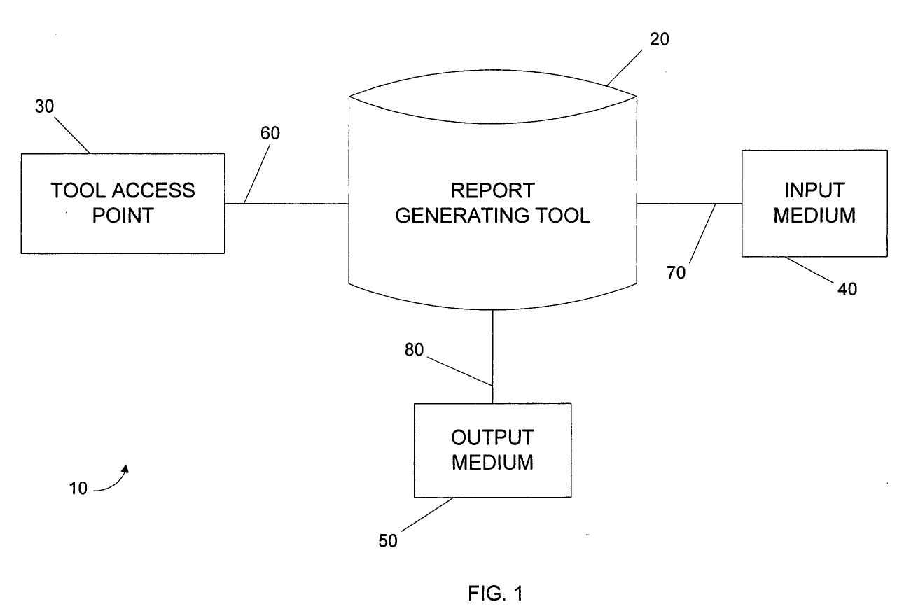

FIG. 1 is a schematic illustration of a report generating system 10 according to one embodiment of the invention. The system 10 can include a report generator tool (hereinafter “tool”) 20, a tool access point 30 (e.g., a workstation or a terminal), a report data storage medium (hereinafter “input medium”) 40, and a report-generating program code storage medium (hereinafter “output medium”) 50. The tool 20 can be connected to the tool access point 30 by a connection 60. The tool 20 can also be connected to the input medium 40 and the output medium 50 by connections 70 and 80, respectively. It should be understood that the connections 60, 70, and 80 can include wired and/or wireless connections. The connections 60, 70, and 80 can be part of a network, such as a local area network or the Internet. It should also be understood that, although shown as separate components, the tool access point 30 can be combined with tool 20. The tool access point 30 can also be combined with the input medium 40 and/or the output medium 50. The input medium 40 and the output medium 50 can also be combined as a single storage medium. The input medium 40 and the output medium 50 can also each include multiple discrete storage mediums.

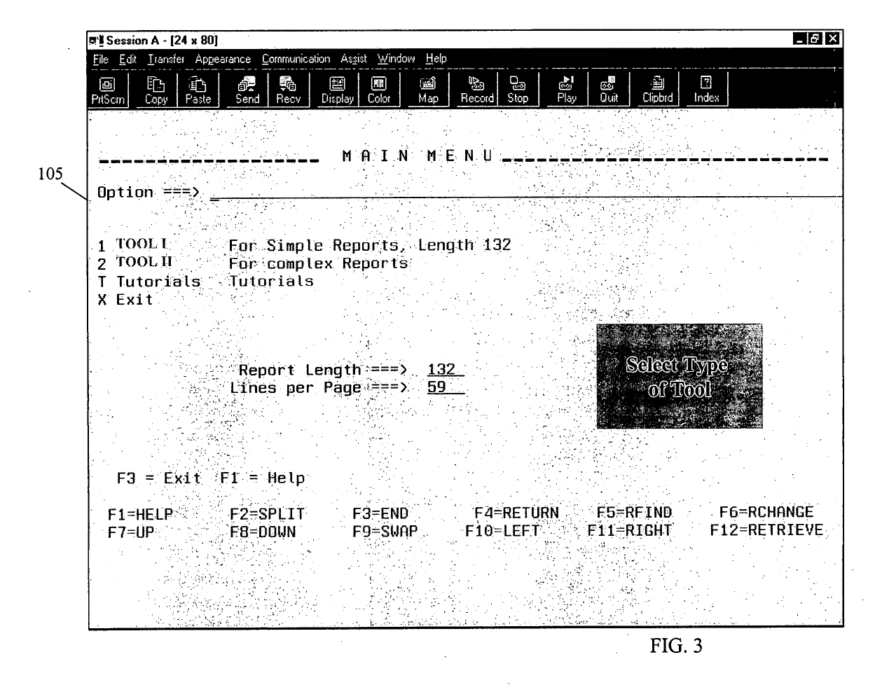

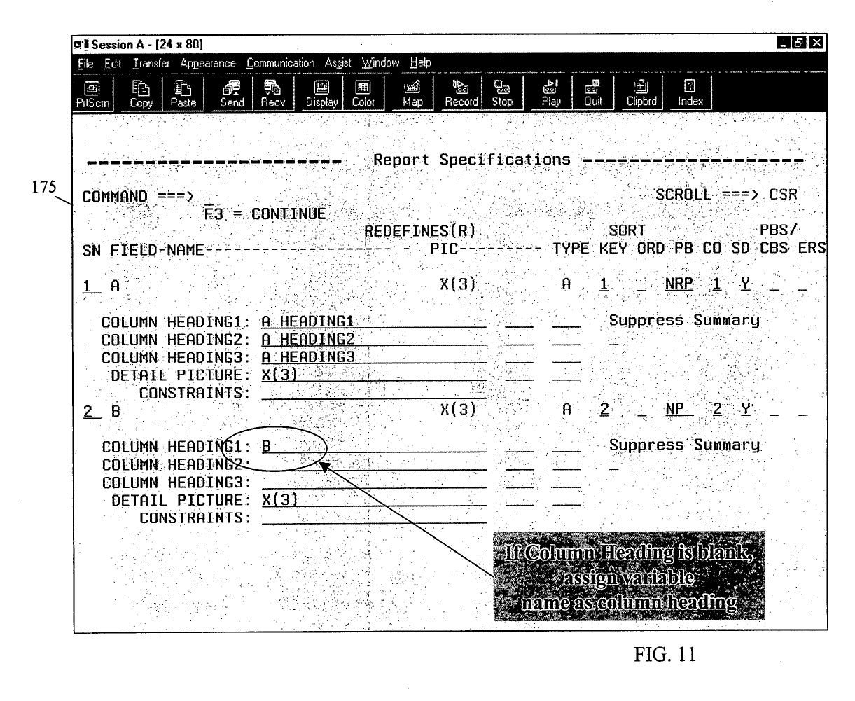

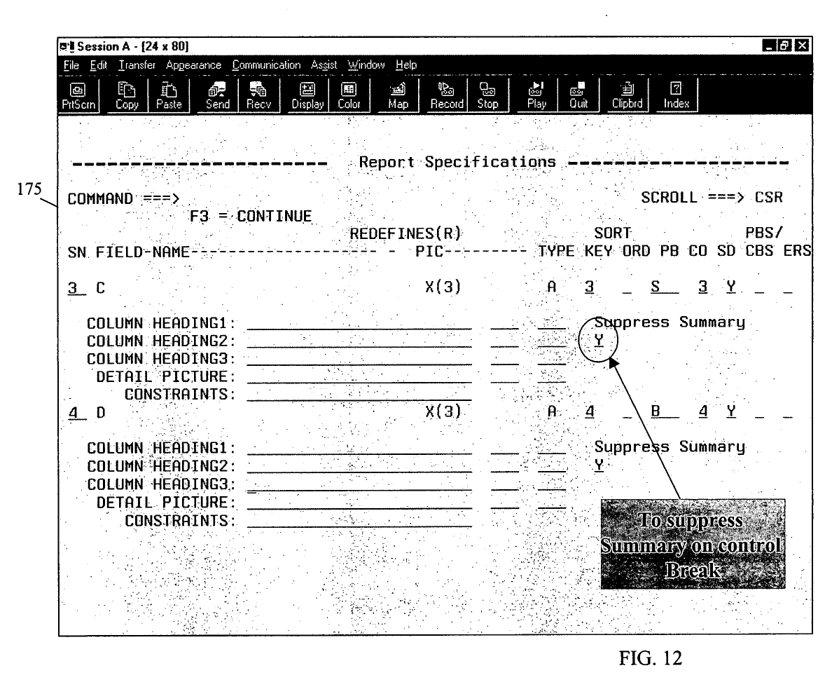

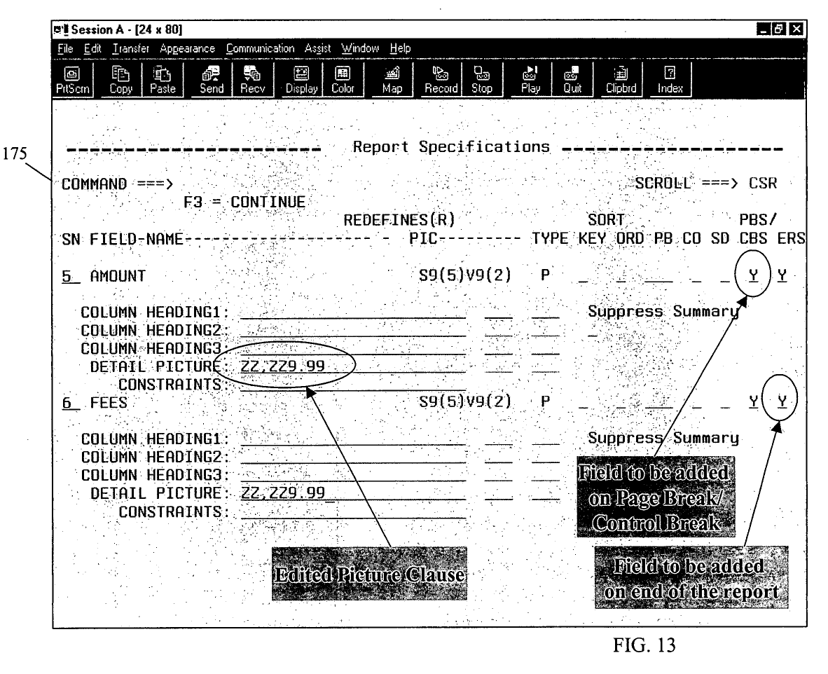

A user can use the tool access point 30 to request the production of report-generating program code from the tool 20. In some embodiments, the tool access point 30 (and any input devices included in the tool access point 30) obtains data source indications and formatting instructions from the user. The tool access point 30 can display visual forms or prompts for requesting and obtaining data source indications and formatting instructions from the user. Visual screens that can be displayed by the tool access point 30 are illustrated in FIGS. 3-28 and described below.

The tool access point 30 can transmit the data source indications and the formatting instructions to the tool 20 via the connection 60. The tool 20 can produce report-generating program code based on the data source indications and the formatting instructions. The report-generating program code, when executed, can generate a report including the data indicated by the data source. The data included in the report can also be formatted based on the formatting instructions.

The tool 20 can also obtain the data indicated by the data source. The tool 20 can access the input medium 40 to obtain the data. In some embodiments, the input medium 40 includes a database or a file. The input medium 40 can also include a control card previously generated by the tool 20. In some embodiments, the control card can include the data. The control card can also include formatting instructions, in some embodiments.

The formatting instructions can include instructions for configuring a report length. For example, the tool 20 can generate a report with up to approximately 9999 bytes. The formatting instructions can also include instructions for configuring lines per page of the report. In some embodiments, 59 lines per page are generated by default if no specific lines per page formatting instructions are obtained. The formatting instructions can include instructions specifying control breaks. For example, the tool 20 can provide 9 levels of control breaks. The formatting instructions can include instructions for performing internal sorting. In some embodiments, the tool 20 can sort up to a maximum of approximately 9 keys. The formatting instructions can include instructions for specifying the summation of field for control total, page total, and end of report total. The formatting instructions can also include instructions for suppressing duplicate details fields and/or suppressing a summary at control.

The formatting instructions can include customization instructions. The customization instructions can specify customized page heads with variables and text, customized control headings with variables and text, customized control footers, and customized end-of-the-report headers with variables and text. The tool 20 can provide system fields that are associated with variables included in customizations. For example, the tool 20 can include system date and time fields that can be associated with variables included in customizations.

The tool 20 can include a restructured, extended executor configured to write an optimized, formatted and engineered program that, when executed, generates a report. In some embodiments, the tool 20 generates common business-orientated language (“COBOL”) program code. The tool 20 can provide the additional functionality of compiling and executing of the generated program code. The tool 20 can also provide field level help and tutorials. The tool 20 can also provide an on-line tool execution monitor.

After generating the report-generating program code, the tool 20 can transmit the program code to the output medium 50. The tool 20 can transmit the program code to the output medium 50 via the connection 80. In some embodiments, the user can retrieve the stored program code from the output medium 50 and can modify the program code.

The tool 20 can be configured to compile the program code to generate executable report-generating program code. The tool 20 can be configured to store the executable report-generating program code in the output medium 50. In some embodiments, the tool 20 can also execute the executable report-generating program code and can store a generated report in the output medium 50.

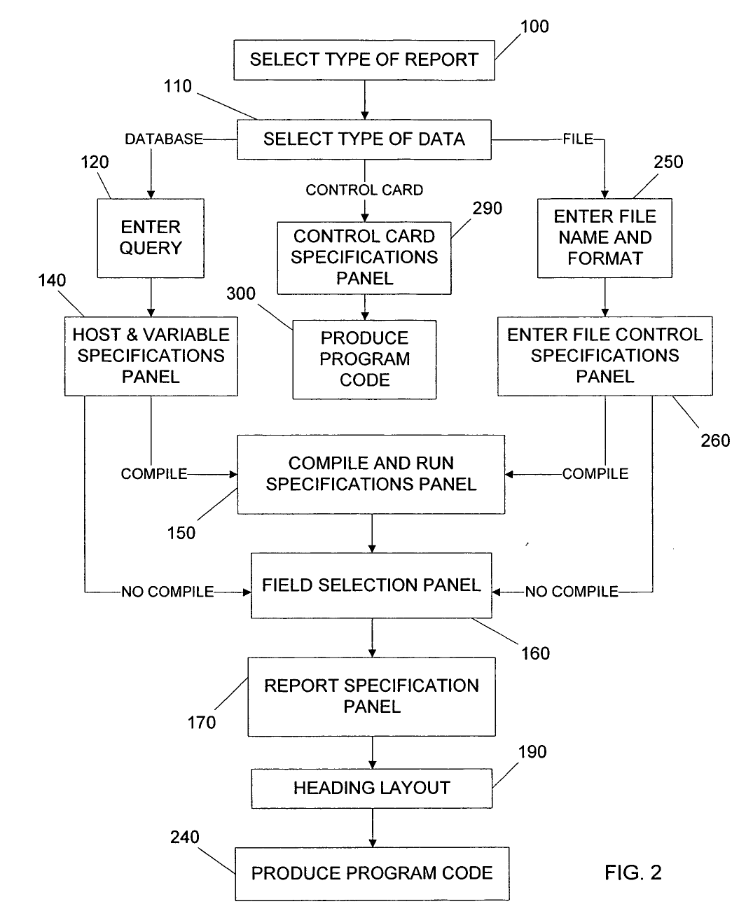

According to a method embodying the invention shown in FIG. 2, a user can select (at 100) a type of report. FIG. 3 illustrates a “MAIN MENU” screen 105 according to one embodiment of the invention. In some embodiments, the tool 20 can include one or more tools that produce different types of program code for different types of reports. For example, selecting the ‘TOOL I’ option can provide a first tool that produces program code that generates reports of length up to approximately 132 pages. Selecting ‘TOOL II’ option can provide a second tool that produces program code that generates more complex or lengthy reports. In some embodiments, the first tool can generate default program code to generate default reports and the second tool can generate customized program code. As shown in FIG. 3, the user can specify the report length and the number of lines per page. The user can also select the ‘Tutorials’ option to receive help with operating the tool 20.

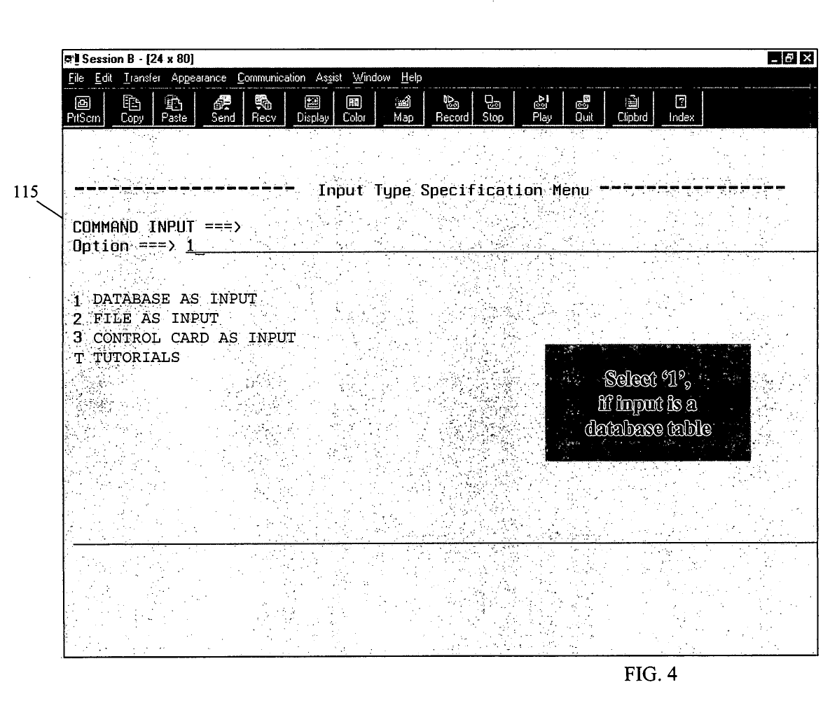

After the user selects a type of report, the user can select (at 110) an indication of a source or type of data. The data will be included in the report generated by executing the program code produced by the tool 20. In some embodiments, the tool access point 30 displays an input type specification menu that allows the user to select an indication of the source or type of data to be input to the program code. FIG. 4 illustrates an “Input Type Specification Menu” screen 115 according to one embodiment of the invention. In some embodiments, the type of data can include a file, such as a virtual storage access method (“VSAM”) file or a queued sequential access method (“QSAM”) file. The type of data can also include a query that, when executed, retrieves data from a database. The type of data can also include a control card generated by the tool 20.

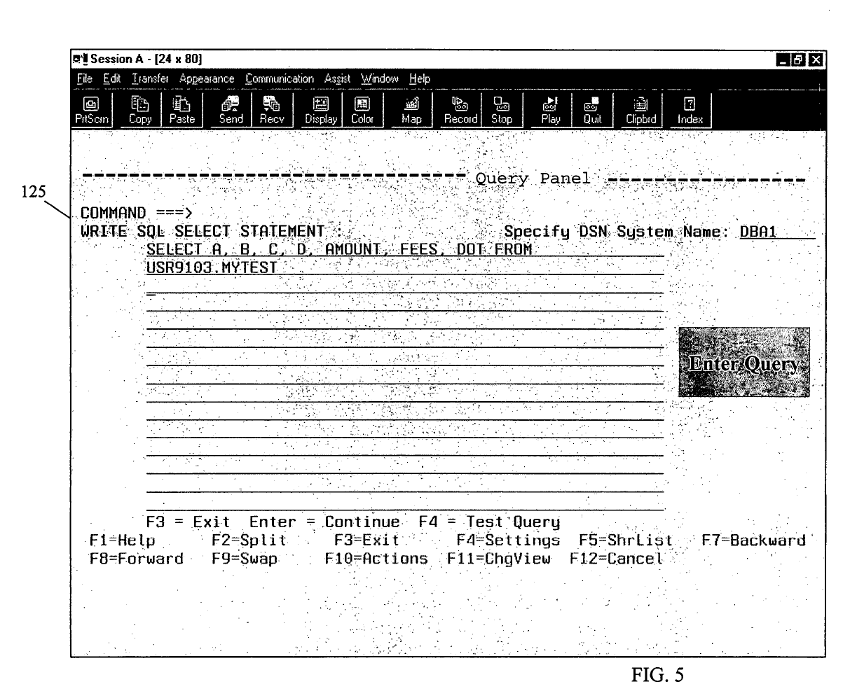

Selecting the ‘1 DATABASE AS INPUT’ option allows the user to enter queries (at 120), such as standard query language (“SQL”) queries. FIG. 5 illustrates a “Query Panel” screen 125 according to one embodiment of the invention. The user can also enter a database table declaration generator. In some embodiments, the input medium 40 includes a database management system, such as DB2, and the user can input a description generator (“DCLGEN”) of the specified SQL query that generates DB2 SQL data structures in COBOL programs. In some embodiments, the host variables must be selected serially (numeric) depending on the SQL query column sequence. As shown in FIG. 5, the user can also enter the dataset name (“DSN”) system name.

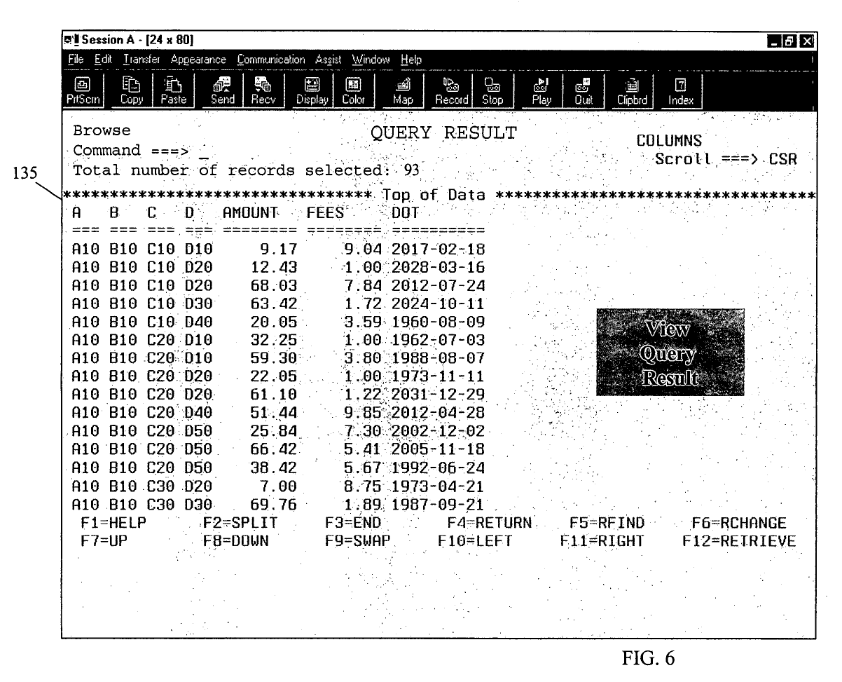

In some embodiments, after the user enters the query, the tool 20 can execute the query to retrieve data from a database. The tool 20 can transmit the results of executing the query to the tool access point 30. The tool access point 30 can display the query results for the user. FIG. 6 illustrates a “QUERY RESULT” screen 135 according to one embodiment of the invention. The user can review the query results and can determine if the results include the intended report data.

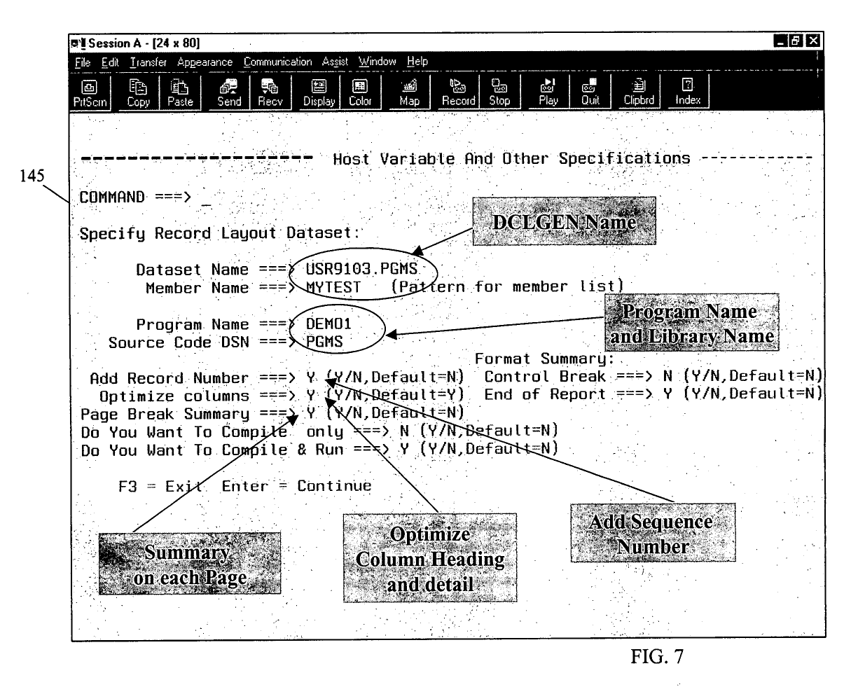

The user can then specify (at 140) host and variable specifications. FIG. 7 illustrates a “Host Variable and Other Specifications” screen 145 according to one embodiment of the invention. In some embodiments, the user can enter the DSN and member name where the previously-entered DCLGEN is stored. The user can enter a program name and a source code DSN. The program name will be assigned to the program code produced by the tool 20. The source code DSN specifies the library name where source code is to be stored. In some embodiments, if a DSN does not have quests, then a user identification may be prefixed to the DSN to distinguish one user's code from another.

As shown in FIG. 7, the user can specify whether he or she wants to add a record number. Entering a “Y” can add a sequence number in each detail record of the report. In some embodiments, size bytes are reserved for sequence number and only remaining bytes are available for details columns. The user can specify whether the tool 20 should optimize the column headings and details. In some embodiments, the tool 20 can optimize the headings by automatically positioning the start and end positions of the column headings and detail. Entering ‘N’ for this option can allow the user to specify the start position and length of the column headings and details.

The user can specify whether the report should include a summary at the end of each page. In some embodiments, a separate screen or prompt is displayed to allow the user to write text and variables for the summary. The user can also specify whether he or she wants to format an end-of-report summary. A separate screen or prompt can be displayed for the user to specify text and variables to appear in the end-of-report summary.

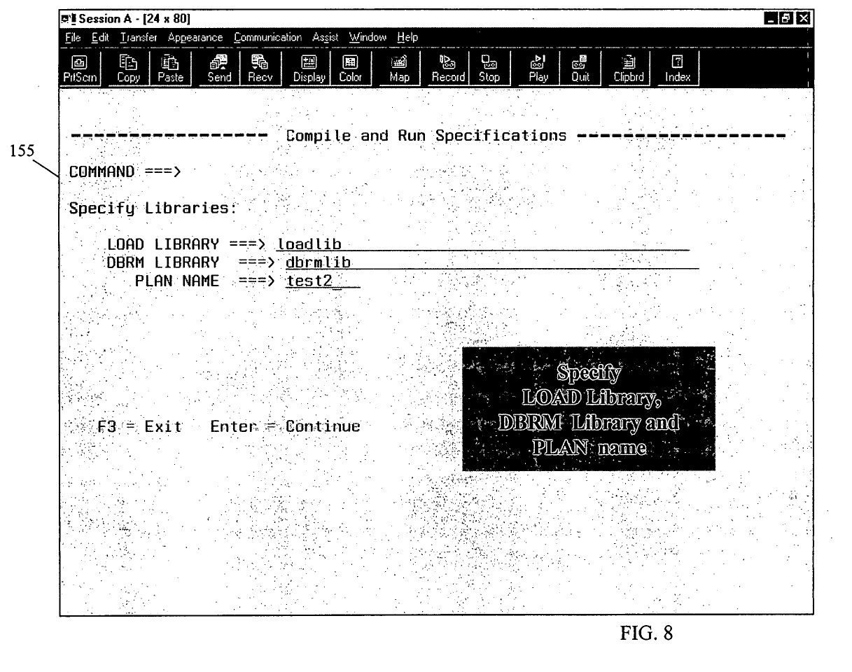

The user can specify whether he or she wants to compile the source code or if he or she wants to compile the source code and run the related execution. If the user enters “Y” for the “Do You Want to Compile only” option or the “Do You Want to Compile & Run” option, as shown in FIG. 7, the user enters (at 150) compilation related inputs. FIG. 8 illustrates a “Compile and Run Specifications” screen 155 according to one embodiment of the invention. The compilation related inputs can include a load library specification. The user can specify the load library name where the load module is to be stored. The compilation related input can include a database request module (“DBRM”) library name where the DBRM is to be stored. In some embodiments, if the library name or the DBRM name does not have quotes, a user identification can be prefixed before the name.

The compilation related inputs can also include a plan name. In some embodiments, if the plan name is blank, the program name will be assumed the same as the plan name.

In some embodiments, the “Compile and Run Specifications” screen 155 can also obtain execution related inputs. A separate screen can also be provided to obtain execution related inputs if the user enters “Y” for the “Do You Want to Compile & Run” option shown in FIG. 7.

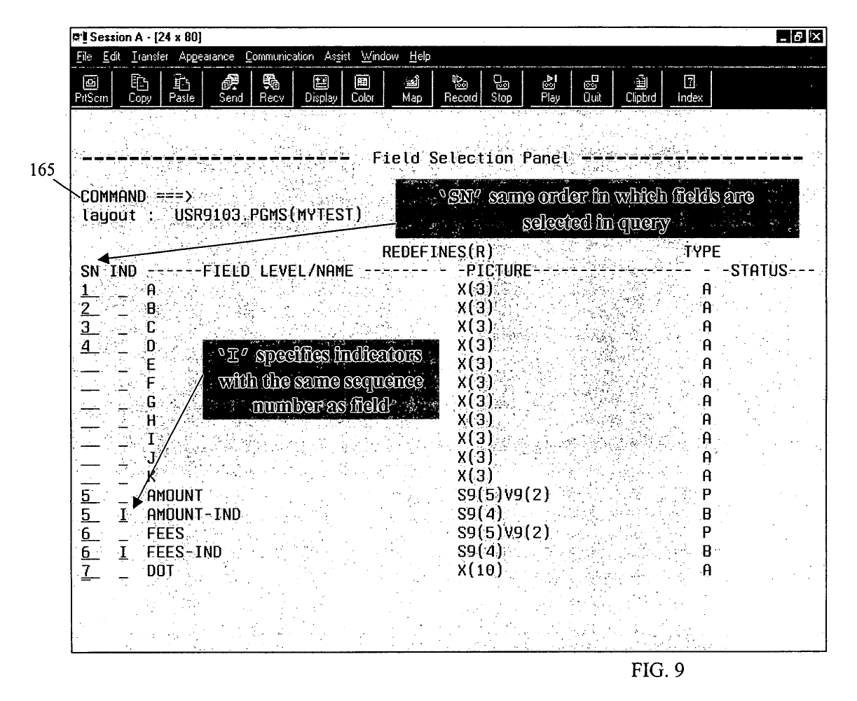

After the user provides the host and variable specifications and the compilation related inputs (if necessary), the user can select (at 160) data fields to be included in the report. FIG. 9 illustrates a “Field Selection Panel” screen 165 according to one embodiment of the invention. As shown in FIG. 9, the sequence numbers associated with each data field can be assigned based on the order that the data fields where selected by the query. In some embodiments, the user can use the screen 165 to make sure that the field order is the same as defined in the query. For not “NOT NULL” columns, the user can enter an “I” in an indicator field (“IND”) with the same sequence number as the original data field.

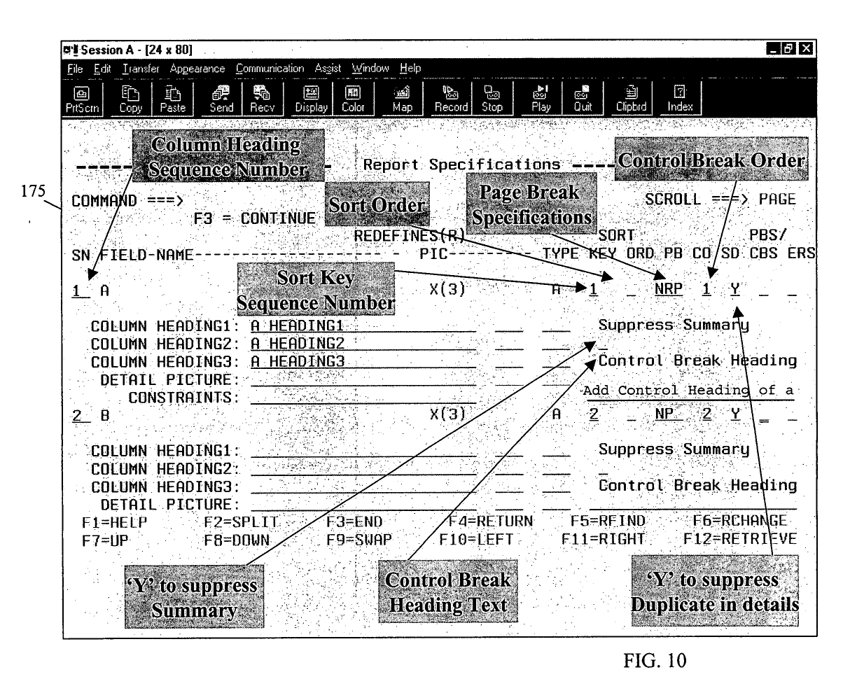

After selecting data fields, the user can enter (at 170) report specifications. FIGS. 10-13 illustrate a “Report Specifications” screen 175 according to one embodiment of the invention. As shown in FIGS. 10-13, the report specifications can include a sequence number (“SN”) that specifies the sequence number in which columns are to be displayed in the report.

For each column, the tool 20 can provide heading formatting options. In some embodiments, the user can specify standard text and variables in a heading. The user can associate each variable with a data field or with a standard variable provided by the tool 20. For example, the tool 20 can provide current date and time variables that the user can use in headings.

To format report headings, the user can enter one or more column headings for each data field. As shown in FIGS. 10-13, the user can specify a first, second, and third column heading. In some embodiments, if the first column heading is blank and the data field is selected to be included in the report, then a variable name will be inserted in the column heading.

As also shown in FIG. 10-13, the user can specify a sort key sequence number for each data filed. The user can also specify a sort order of the key. The sort order can be set to “A” ascending or “D” descending. In some embodiments, sort order is set to ascending by default.

The user can specify page break definitions for control breaks. In some embodiments, the user can set a page break with a new serial number and a new page number, a page break with a new page number only, a page break with no renumbering of page number or serial number, or no page break (only a control break). The user can also specify a control order that specifies the control order in which fields are to be controlled. In some embodiments, the control order is a numeric number. Control break heading entry space is also provided on the screen 175. The user can write text in the space. The tool 20 can attach the data field name to the text in source code.

In some embodiments, the user can specify the suppression of duplicate values in the report and the suppression of a summary on a control break when the report is printed. The user can specify whether he or she wants a page break sum (“PBS”) and/or a control break sum (“CBS”) printed on the report. Furthermore, the user can enter a ‘Y’ to have an end of report sum (“ERS”) printed at the end of the report. In some embodiments, the tool will only generate sums when the data field is a numeric type data field.

The user can specify an edited picture clause to be displayed in the report. In some embodiments, the edited picture clause is in a COBOL format. In some embodiments, if an edited picture clause is not specified, the tool 20 assumes the field picture clause as specified in the file layout.

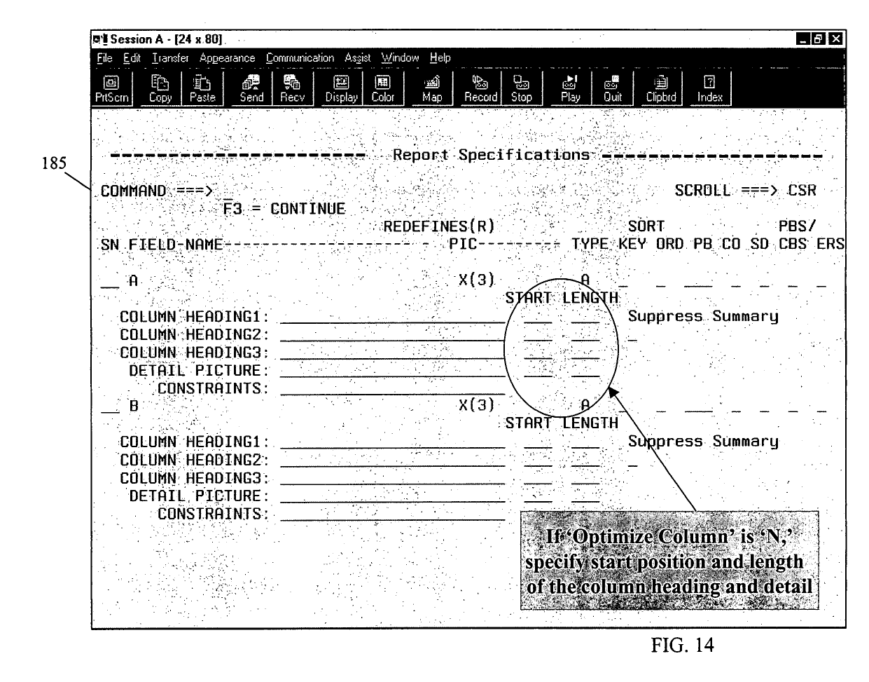

If the “Optimize Column” option was previously set to “N” (as shown in FIG. 7), the user can set a start position for a column heading and a length for the column heading. FIG. 14 illustrates another “Report Specifications” screen 185 that allows the user to specify the start position and the length of a column heading and details. In some embodiments, if the user does not specify a length, the tool 20 determines the length of the specified column heading and details, and places the value in the length field. In some embodiments, the tool 20 prohibits overlapping between column headings and/or details.

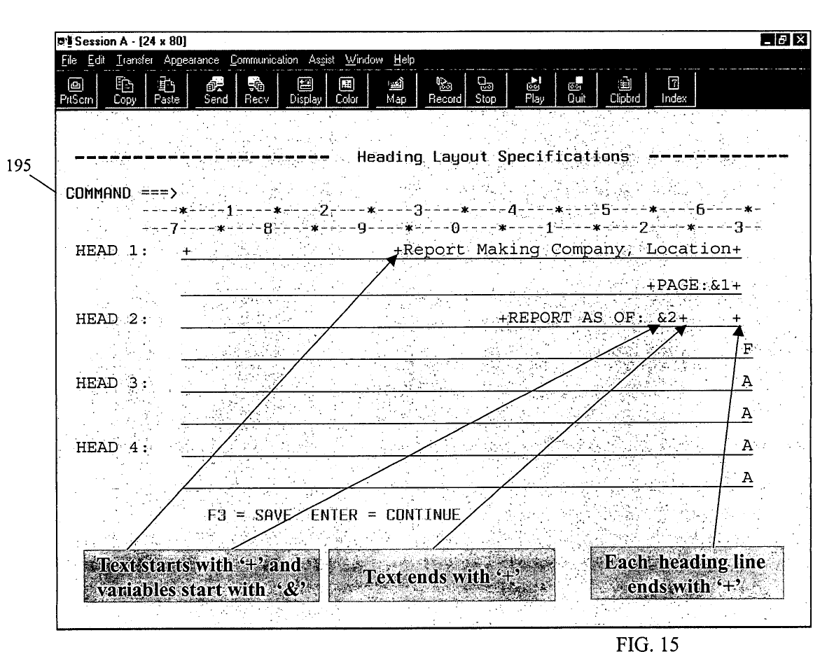

After the user specifies report specifications, the user can enter (at 190) a heading layout. FIG. 15 illustrates a “Heading Layout Specifications” screen 195 according to one embodiment of the invention. When entering a heading layout, the user can mix text and variables. In some embodiments, to distinguish text from variables, all text (including spaces) start with a “+” sign and all variables start with a “&” sign. All text and variables can end with a “+” sign or a “&” sign. Each heading line can end with a “+” sign. Variables in the heading can also be numbered.

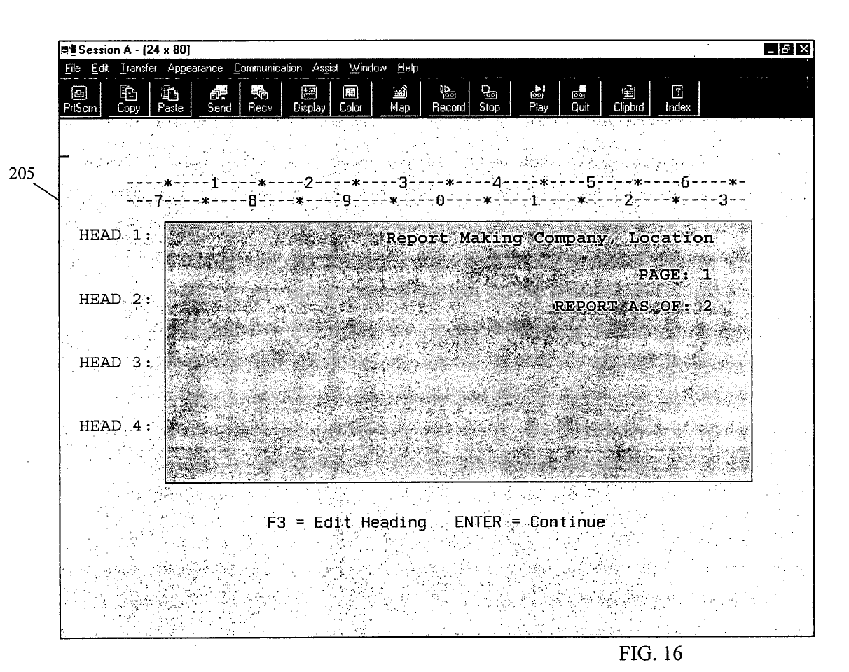

After specifying a heading layout, the tool 20 can display a preview screen. FIG. 16 illustrates a preview screen 205 according to one embodiment of the invention. The user can view the preview screen 205 and can make adjustments to the text and variables included in the heading. In some embodiments, the preview screen 205 displays the heading as it will look in the actual report when generated.

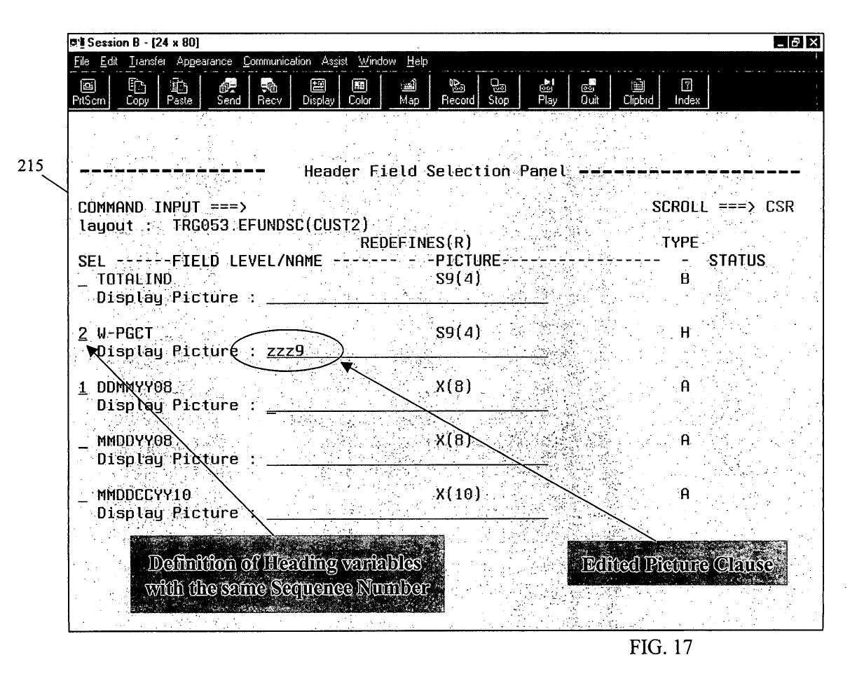

If the heading layout specified by the user contains variables, the user can assign a variable number to each variable. FIG. 17 illustrates a “Header Field Selection Panel” screen 215 according to one embodiment of the invention. The user can enter a variable number to relate with a specified variable. The user can also enter a display picture clause for each variable. In some embodiments, if the user does not specify a display picture clause, the tool 20 assigns the display picture clause of the data field as defined in the file layout.

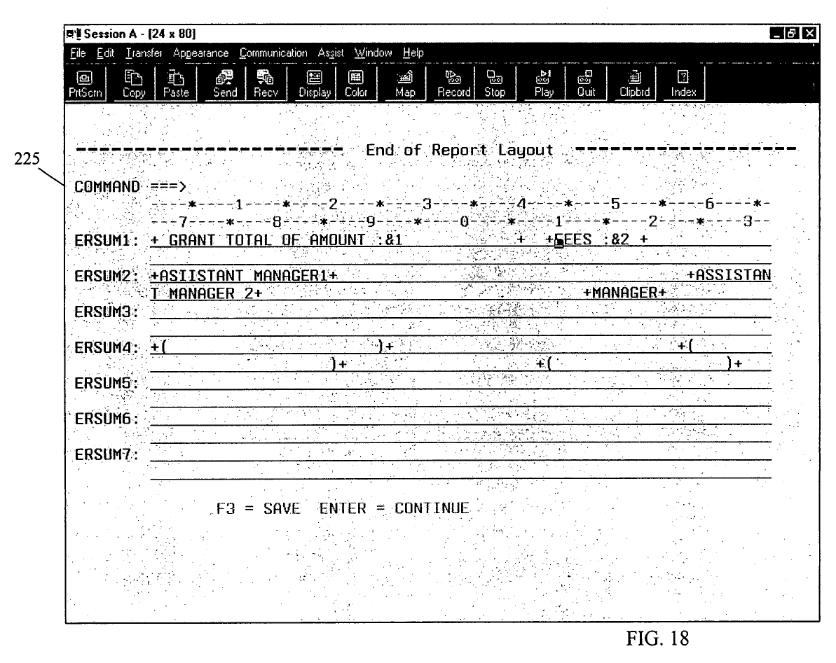

In some embodiments, the user can also specify an end-of-report layout. FIG. 18 illustrates a “End of Report Layout” screen 235 according to one embodiment of the invention. Using the same technique as for specifying a heading layout, the user can specify an end-of-report layout that includes text and variables. In some embodiments, the layout follows the same rules as specified above for distinguishing text from variables.

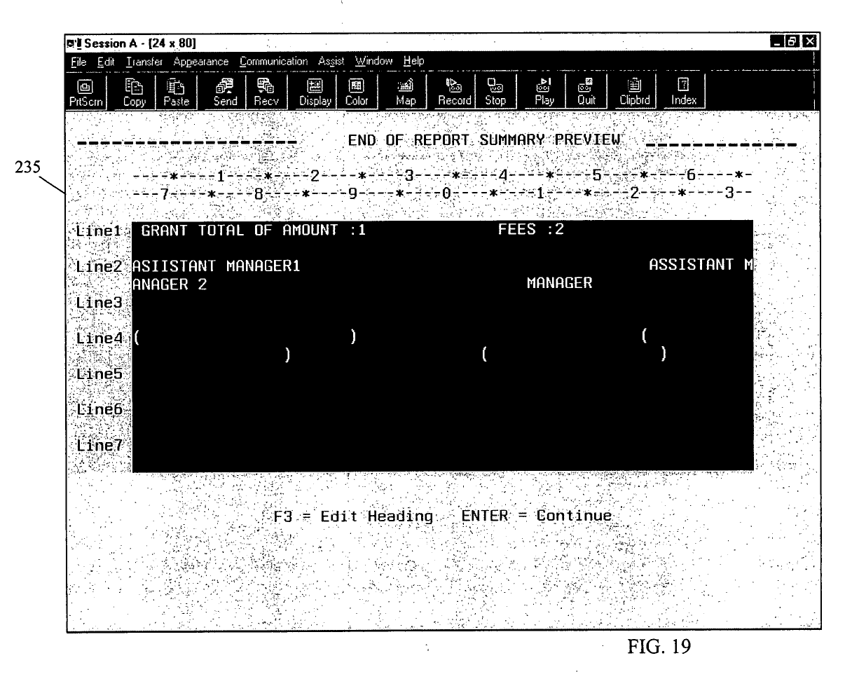

After specifying an end-of-report layout, the tool 20 can generate a preview of the end of the report as specified in the layout. FIG. 19 illustrates a “End of Report Summary Preview” screen 235. In some embodiments, the user can return to the “End of Report Layout” screen 225 to make changes to the layout based on the preview screen 235.

The user can also specify variable numbers and display picture clauses if the end-of-report layout specified by the user contains the variables, as described and illustrated above.

Once the heading formats have been specified, the tool 20 produces (at 240) the program code. Sample program code according to one embodiment of the invention follows.

In some embodiments, the tool 20 produces a control file in addition to the program code based on the entered values. The tool 20 can store the control file in the output medium 50. In some embodiments, the program code is stored according to a program name specified by the user. If the program code is compiled and executed, the generated report can be stored in a physical sequence file. A sample generated report according to one embodiment of the invention follows.

SAMPLE GENERATED REPORT

1 Report Making Company, Location
PAGE: 1
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 1 | A10 | B10 | C10 | D10 | 9.17 | 9.04 | 2017-02-18 |
| 2 | | | | D20 | 12.43 | 1.00 | 2028-03-16 |
| 3 | | | | | 68.03 | 7.84 | 2012-07-24 |
| 4 | | | | D30 | 63.42 | 1.72 | 2024-10-11 |
| 5 | | | | D40 | 20.05 | 3.59 | 1960-08-09 |

1 Report Making Company, Location
PAGE: 2
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 6 | | | C20 | D10 | 32.25 | 1.00 | 1962-07-03 |
| 7 | | | | | 59.30 | 3.80 | 1988-08-07 |
| 8 | | | | D20 | 22.05 | 1.00 | 1973-11-11 |
| 9 | | | | | 61.10 | 1.22 | 2031-12-29 |
| 10 | | | | D40 | 51.44 | 9.85 | 2012-04-28 |
| 11 | | | | D50 | 25.84 | 7.30 | 2002-12-02 |
| 12 | | | | | 66.42 | 5.41 | 2005-11-18 |
| 13 | | | | | 38.42 | 5.67 | 1992-06-24 |

1 Report Making Company, Location
PAGE: 3
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 14 | | | C30 | D20 | 7.00 | 8.75 | 1973-04-21 |
| 15 | | | | D30 | 69.76 | 1.89 | 1987-09-21 |
| 16 | | | | D40 | 26.48 | 2.62 | 1971-02-05 |
| 17 | | | | | 50.65 | 1.90 | 2034-11-25 |
| 18 | | | | D50 | 8.61 | 9.99 | 1974-12-22 |

1 Report Making Company, Location
PAGE: 4
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 19 | | | C40 | D20 | 37.76 | 7.64 | 2032-11-04 |
| 20 | | | | D30 | 41.11 | 4.02 | 1990-12-13 |
| 21 | | | | | 8.69 | 1.00 | 1980-03-18 |
| 22 | | | | D50 | 9.14 | 1.06 | 2018-10-11 |

1 Report Making Company, Location
PAGE: 5
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 23 | | | C50 | D10 | 48.06 | 3.93 | 1964-06-27 |
| 24 | | | | D20 | 48.57 | 6.85 | 2036-03-01 |
| 25 | | | | D30 | 7.00 | 2.72 | 2047-02-21 |
| 26 | | | | | 13.04 | 1.73 | 2010-07-22 |
| 27 | | | | D40 | 69.53 | 7.40 | 1967-07-20 |
| 28 | | | | | 39.27 | 7.37 | 1960-06-16 |
| 29 | | | | D50 | 8.24 | 7.87 | 1966-01-21 |
| 0 | | | | | | | |
| 0 | TOTAL OF B B10 | | | | 1,022.83 | 135.18 | |

1 Report Making Company, Location
PAGE: 1
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 30 | | B20 | C10 | D10 | 21.38 | 8.61 | 1966-10-01 |
| 31 | | | | | 31.30 | 8.50 | 2004-03-11 |
| 32 | | | | | 63.86 | 8.95 | 1972-07-05 |
| 33 | | | | | 51.84 | 1.00 | 1977-09-03 |
| 34 | | | | D30 | 25.48 | 7.23 | 1963-12-19 |
| 35 | | | | D40 | 7.11 | 1.61 | 1980-03-22 |
| 36 | | | | D50 | 37.11 | 1.00 | 1968-05-18 |
| 37 | | | | | 51.51 | 7.10 | 2005-08-09 |
| 38 | | | | | 65.68 | 6.54 | 1955-12-26 |

1 Report Making Company, Location
PAGE: 2
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 39 | | | C20 | D30 | 64.54 | 5.69 | 1957-09-07 |
| 40 | | | | | 48.70 | 8.57 | 1986-09-01 |
| 41 | | | | D40 | 8.36 | 4.71 | 2029-09-06 |
| 42 | | | | | 41.94 | 1.95 | 1982-03-06 |
| 43 | | | | | 10.75 | 8.05 | 2005-11-01 |
| 44 | | | | | 27.79 | 7.33 | 1996-11-24 |
| 45 | | | | D50 | 21.83 | 2.08 | 2009-04-12 |
| 46 | | | | | 17.06 | 1.00 | 1964-09-02 |

1 Report Making Company, Location
PAGE: 3
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 47 | | | C30 | D10 | 45.16 | 2.93 | 2013-10-30 |
| 48 | | | | | 9.22 | 6.45 | 2045-10-26 |
| 49 | | | | | 24.84 | 1.00 | 2032-11-24 |
| 50 | | | | D50 | 19.95 | 2.67 | 2049-02-24 |
| 51 | | | | | 63.37 | 8.23 | 2037-06-28 |
| 52 | | | | | 66.04 | 9.55 | 1957-06-27 |

1 Report Making Company, Location
PAGE: 4
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 53 | | | C40 | D10 | 14.31 | 2.80 | 2006-07-25 |
| 54 | | | | | 33.72 | 3.04 | 1975-10-14 |
| 55 | | | | D20 | 8.79 | 1.86 | 1982-03-20 |
| 56 | | | | D40 | 20.32 | 7.10 | 1989-12-25 |

1 Report Making Company, Location
PAGE: 5
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 57 | | | C50 | D10 | 7.00 | 6.96 | 2043-09-23 |
| 58 | | | | D20 | 51.56 | 6.91 | 2049-09-09 |
| 59 | | | | | 7.00 | 3.56 | 2003-04-09 |
| 60 | | | | | 8.51 | 1.00 | 1955-10-11 |
| 61 | | | | D30 | 10.34 | 7.16 | 2023-10-15 |
| 0 | | | | | | | |
| 0 | TOTAL OF B B20 | | | | 986.37 | 161.14 | |

1 Report Making Company, Location
PAGE: 1
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 62 | | B30 | C10 | D10 | 8.19 | 2.79 | 2021-11-14 |
| 63 | | | | D40 | 30.52 | 4.42 | 2040-04-13 |
| 64 | | | | D50 | 7.53 | 7.62 | 2028-04-16 |

1 Report Making Company, Location
PAGE: 2
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 65 | | | C20 | D10 | 33.73 | 1.25 | 2016-01-20 |
| 66 | | | | | 48.50 | 6.24 | 1958-10-09 |
| 67 | | | | | 13.66 | 4.65 | 1959-01-06 |
| 68 | | | | | 41.56 | 3.44 | 2036-12-28 |
| 69 | | | | | 29.75 | 5.35 | 2037-02-03 |
| 70 | | | | D20 | 25.53 | 7.26 | 2037-06-11 |
| 71 | | | | D30 | 55.31 | 1.32 | 1993-06-03 |
| 72 | | | | D40 | 47.20 | 8.68 | 2014-07-25 |
| 73 | | | | D50 | 8.68 | 4.35 | 1999-06-13 |
| 74 | | | | | 46.96 | 3.48 | 2047-04-22 |
| 75 | | | | | 20.89 | 1.90 | 1978-11-28 |

1 Report Making Company, Location
PAGE: 3
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 76 | | | C30 | D10 | 32.86 | 9.75 | 2031-05-22 |
| 77 | | | | | 53.14 | 9.91 | 2039-11-08 |
| 78 | | | | D40 | 58.54 | 5.25 | 1995-12-16 |
| 79 | | | | D50 | 21.77 | 1.00 | 1999-11-23 |

1 Report Making Company, Location
PAGE: 4
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 80 | | | C40 | D10 | 48.27 | 9.81 | 1965-03-15 |
| 81 | | | | D20 | 15.67 | 6.47 | 1991-03-23 |
| 82 | | | | | 21.54 | 1.00 | 1977-01-01 |
| 83 | | | | D40 | 46.33 | 6.86 | 2022-04-20 |
| 84 | | | | | 24.40 | 6.66 | 1981-10-21 |
| 85 | | | | D50 | 38.88 | 5.19 | 2033-02-27 |

1 Report Making Company, Location
PAGE: 5
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 86 | | | C50 | D10 | 9.93 | 5.00 | 2021-06-06 |
| 87 | | | | | 15.50 | 7.48 | 1970-11-29 |
| 88 | | | | D20 | 8.71 | 8.31 | 1958-09-08 |
| 89 | | | | | 35.55 | 1.86 | 2007-03-14 |
| 90 | | | | D30 | 22.86 | 4.57 | 2004-12-08 |
| 91 | | | | D40 | 9.72 | 1.99 | 1991-11-10 |
| 92 | | | | D50 | 34.55 | 3.98 | 1960-02-16 |
| 0 | | | | | | | |
| 0 | TOTAL OF B B30 | | | | 916.23 | 157.84 | |
| 0 | | | | | | | |
| 0 | TOTAL OF A A10 | | | | 2,925.43 | 454.16 | |

1 Report Making Company, Location
PAGE: 1
REPORT AS ON: 99/99/99

| 0SN | A HEADING1 | B | C | D | AMOUNT | FEES | DOT |
|---|---|---|---|---|---|---|---|
| | A HEADING2 | | | | | | |
| | A HEADING3 | | | | | | |
| 0 1 | A20 | B10 | C10 | D10 | 7.00 | 7.96 | 1957-07-15 |
| 0 | | | | | | | |
| 0 | TOTAL OF B B10 | | | | 7.00 | 7.96 | |
| 0 | | | | | | | |
| 0 | TOTAL OF A A20 | | | | 7.00 | 7.96 | |
| 0 | | | | | | | |

| | |
|---|---|
| 0 | GRAND TOTAL OF AMOUNT: 2,932.43 FEES: 462.12 |

ASIISTANT MANAGER1 ASSISTANT MANAGER 2 MANAGER
( ) ( ) ( )

| | |
|---|---|
| 0 | E N D O F R E P O R T |

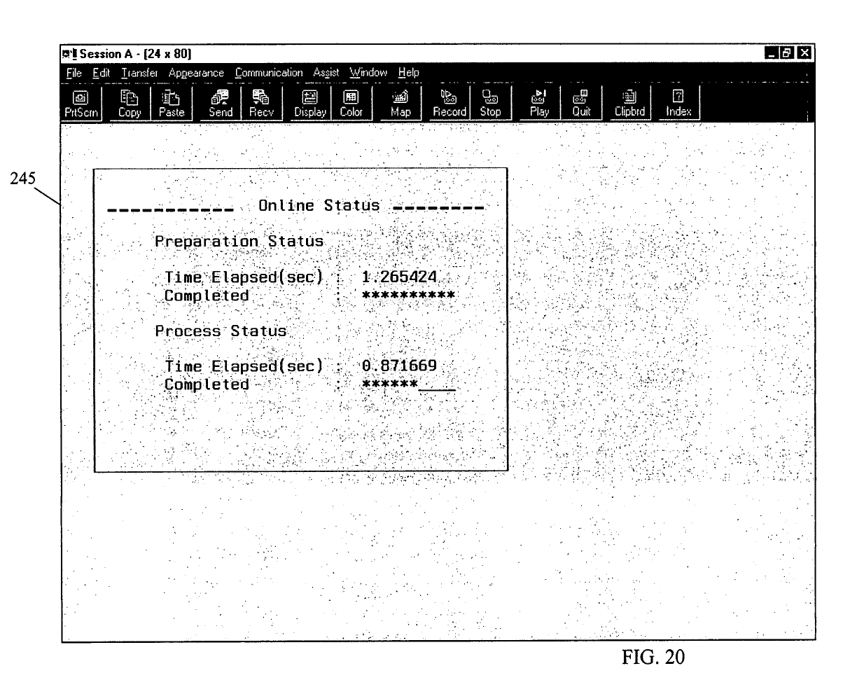

While the program code is being produced (and compiled and executed, if applicable), the tool 20 can display an on-line monitoring screen. FIG. 20 illustrates an “Online Status” screen 245 according to one embodiment of the invention. The screen 245 can display a time elapsed and a percent completed for preparing and processing the program code.

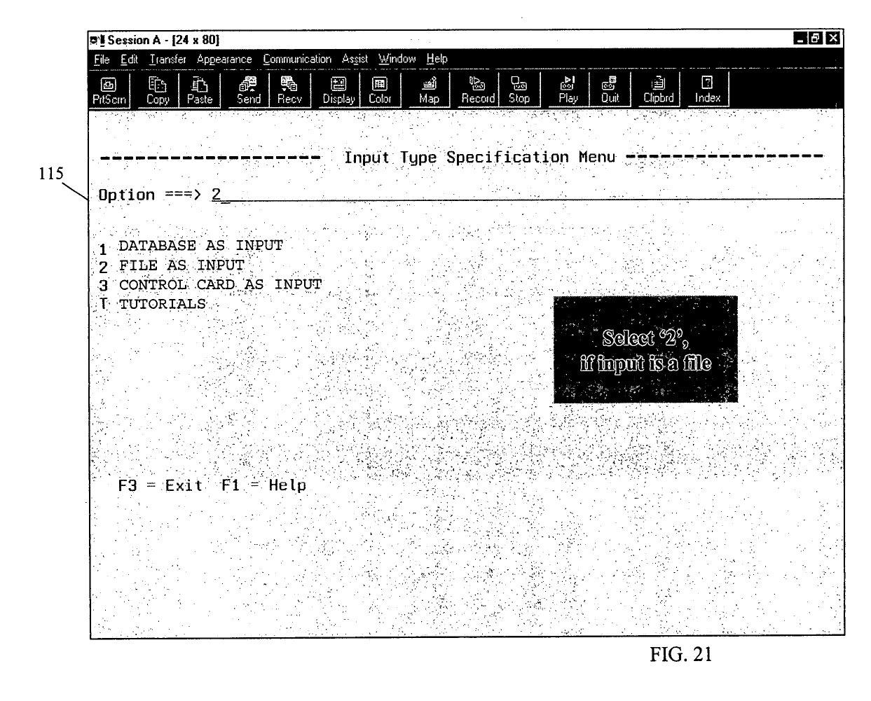

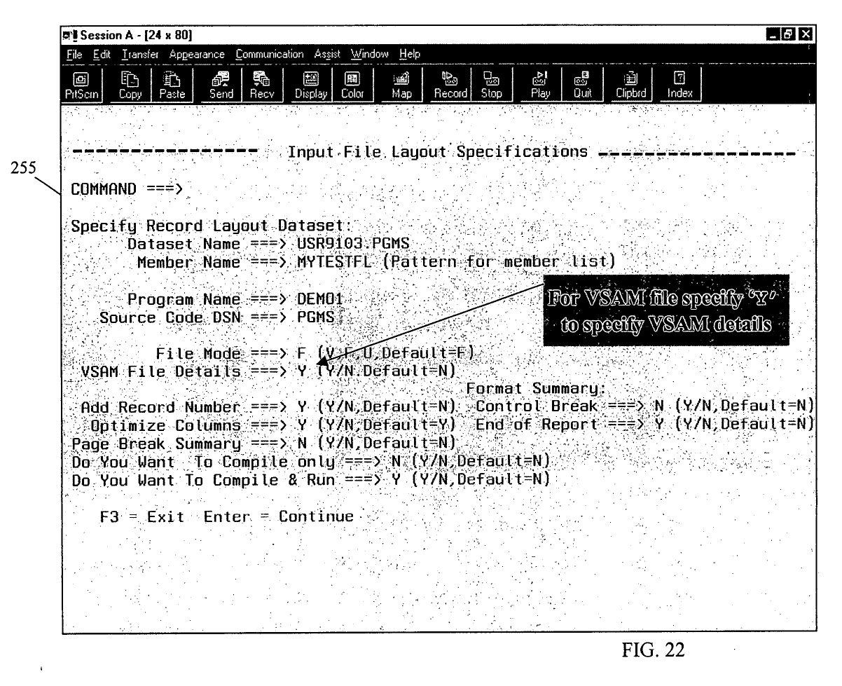

Rather than selecting the “1 DATABASE AS INPUT” option, the user can select the “2 FILE AS INPUT” option from the “Input Type Specification Menu” screen 115 shown in FIG. 21 to specify that the data is contained in a file. Selecting the “2 FILE AS INPUT OPTION” allows the user to specify (at 250) a file and a file format or layout. FIG. 22 illustrates a “Input File Layout Specification” screen 255 according to one embodiment of the invention. The user can use the screen 255 to enter a DSN and member name that specifies the DSN and member where a file layout is stored. The user can also enter a program name and a source code DSN. The source code DSN can specify the library name where source code is to be stored. If the DSN does not have quotes, a user identification can be prefixed to the DSN name.

The user can also specify a file mode and VSAM file details. In some embodiments, the file mode specifies the file mode of the input file. The default mode can be a fixed file mode. The file mode specification can only be applicable to particular file types, such as QSAM file.

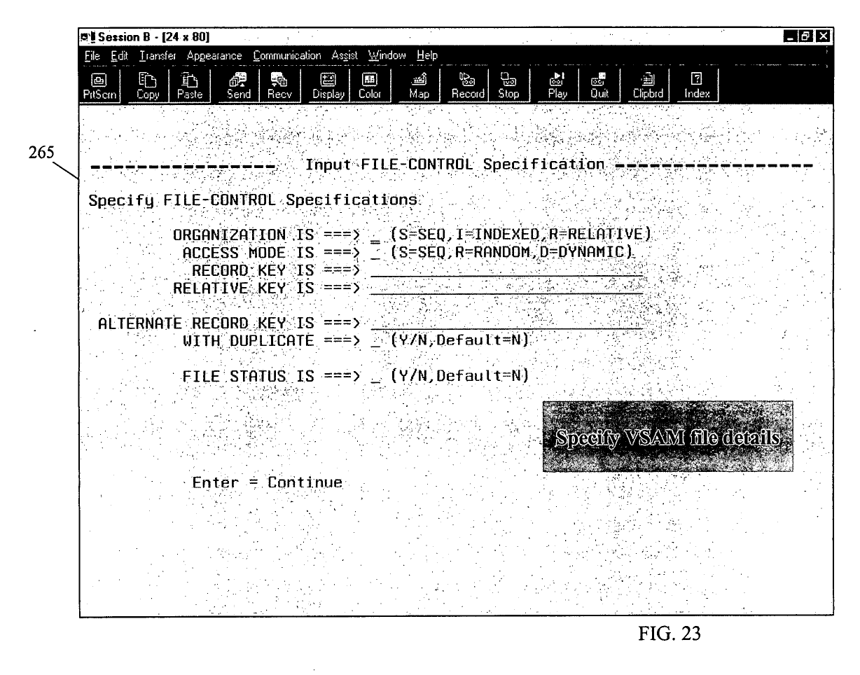

If the user enters “Y” for the “VSAM File Details” option, as shown in FIG. 22, the user can supply (at 260) further file details. FIG. 23 illustrates an “Input FILE-CONTROL Specification” screen 265 according to one embodiment of the invention. The user can use the screen 265 to specify the organization, the access mode, the relative keys, and the alternate keys.

As shown in FIG. 22, the user can use the screen 255 to specify whether he or she wants to add a record number. Entering a “Y” can add a sequence number in each detail record of the report. In some embodiments, size bytes are reserved for sequence number and only remaining bytes are available for details columns. The user can specify whether the tool 20 should optimize the column headings and details. In some embodiments, the tool 20 can optimize the headings by automatically positioning the start and end positions of the column headings and detail. Entering “N” for this option can allow the user to specify the start position and length of the column headings and details.

The user can specify whether the report should include a summary at the end of each page. In some embodiments, a separate screen or prompt is displayed to allow the user to write text and variables for the summary. The user can also specify whether he or she wants to format an end-of-report summary. A separate screen or prompt can be displayed for the user to specify text and variables to appear in the end-of-report summary.

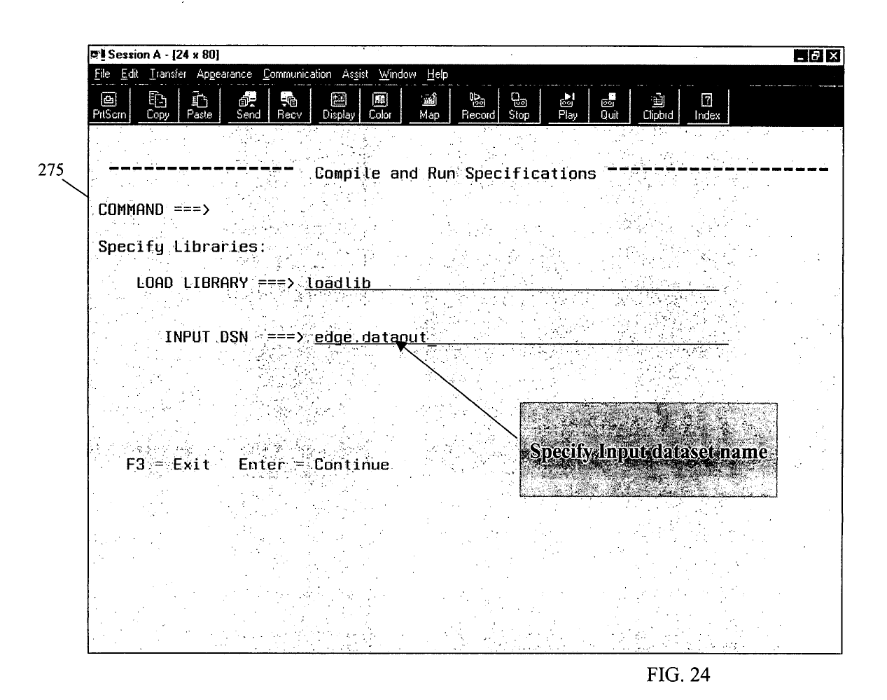

The user can specify whether he or she wants to compile the source code, or if he or she wants to compile the source code and run the related execution. If the user enters “Y” for the “Do You Want to Compile only” option or the “Do You Want to Compile & Run” option, as shown in FIG. 22, the user enters (at 150) compilation related inputs. FIG. 24 illustrates a “Compile and Run Specifications” screen 275 according to one embodiment of the invention. The compilation related inputs can include a load library specification. The user can specify the load library name where the load module is to be stored. In some embodiments, if the user entered ‘Y’ for the ‘Do You Want to Compile & Run’ option, the user specifies an input DSN.

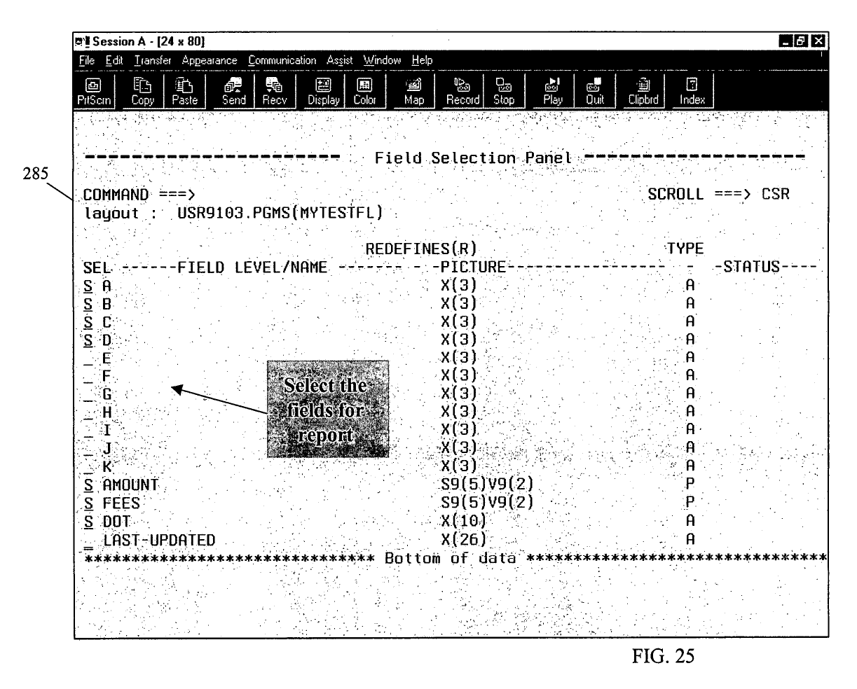

After the user provides the host and variable specifications and the compilation related inputs (if necessary), the user can select (at 160) data fields. The selected data fields can be processed (at 240) in order to prepare a report. FIG. 25 illustrates a “Field Selection Panel” screen 285 according to one embodiment of the invention. As shown in FIG. 25, to select a field, an “S” is entered next to the data field.

After the user selects data fields, the user can specify report specifications (at 170) and a heading layout (at 180) as shown and described with respect to FIGS. 10-19. The user can also specify an end-of-report layout. The tool 20 then produces (at 240) the program code and stores the program code (and the compiled code and execution results). In some embodiments, the tool 20 displays the on-line monitoring screen, as shown in FIG. 20.

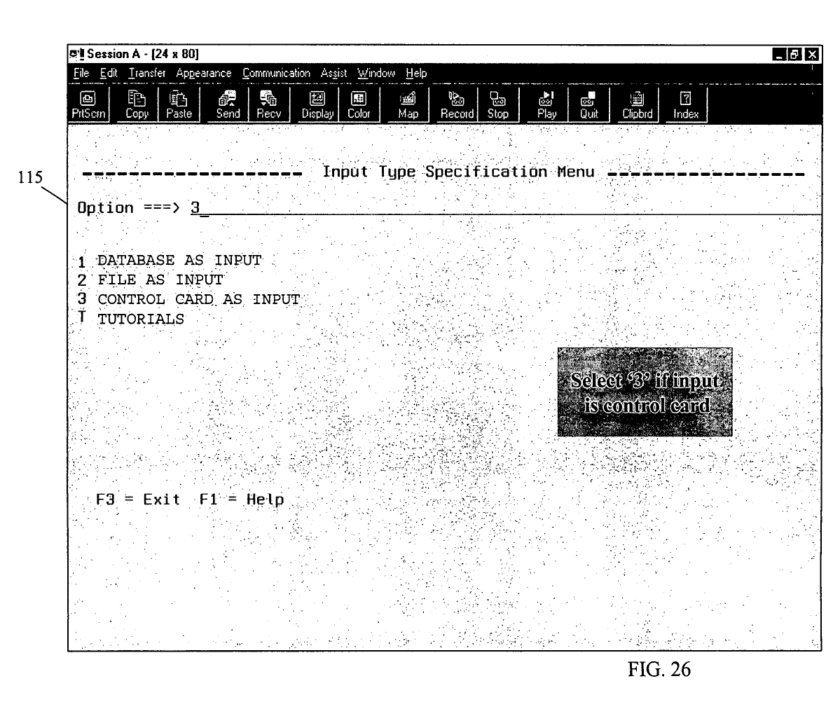

A third data type option can include a “3 CONTROL CARD AS INPUT” option. The user can select the “3 CONTROL CARD AS INPUT” option from the “Input Type Specification Menu” screen 115 (as shown in FIG. 26). Selecting the “3 CONTROL CARD AS INPUT” allows the user to input the DSN of a previously-generated control card.

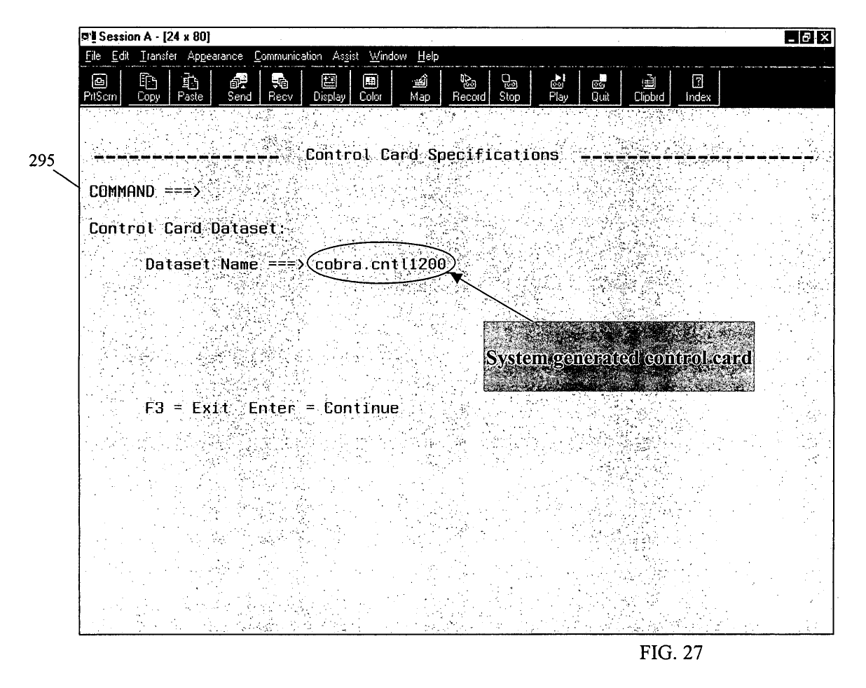

After selecting the “3 CONTROL CARD AS INPUT” option, the user specifies (at 290) control card specification. FIG. 27 illustrates a “Control Card Specifications” screen 295 according to one embodiment of the invention. The user can use the screen 295 to specify the control card name. In some embodiments, the control card name is set or prepared by tool 20 when it is generated. The user can also specify a control card DSN. If the DSN does not include quotes, a user identification is prefixed to the name.

After the user specifies the control card name and the control card DSN, the tool 20 produces (at 300) the program code and stores the program code (and the compiled code and execution results). The tool 20 can also display the on-line monitoring screen as shown in FIG. 20. In some embodiments, the user can specify report specifications, a heading layout, and/or a report layout as shown and described with respect to FIGS. 10-20.

Various features and advantages of the invention are set forth in the following claims.

1. A method of producing report-generating program code, the method comprising:
obtaining an indication as to a source of data to be included in a report generated by the execution of the report-generating program code;
retrieving data from the source;
obtaining formatting instructions for the data to be included in the report-generating program code; and
producing the report-generating program code based on the data and the formatting instructions.

2. The method of claim 1 and further comprising producing the report-generating program code including common business-orientated language code.

3. The method of claim 1 and further comprising obtaining an indication as to whether the source of the data includes at least one of a database, a file, and a control card.

4. The method of claim 1 and further comprising obtaining a standard query language select statement.

5. The method of claim 4 and further comprising executing the standard query language select statement to obtain the data from a database.

6. The method of claim 1 and further comprising obtaining the name of a file including the data.

7. The method of claim 6 and further comprising obtaining a format of the file.

8. The method of claim 6 and further comprising retrieving the data from the file.

9. The method of claim 1 and further comprising displaying the data.

10. The method of claim 9 and further comprising obtaining an indication as to a subset of the data to be included in a report generated by executing the report-generating program code.

11. The method of claim 1 and further comprising providing report heading formatting instructions.

12. The method of claim 11 and further comprising providing report heading formatting instructions including a variable.

13. The method of claim 12 and further comprising associating the variable with the data or a standard variable.

14. The method of claim 1 and further comprising storing the report-generating program code in a storage medium.

15. The method of claim 1 and further comprising allowing a user to modify the report-generating program code.

16. The method of claim 1 and further comprising generating executable report-generating program code from the report-generating program code.

17. The method of claim 16 and further comprising storing the executable report-generating program code in a storage medium.

18. The method of claim 16 and further comprising executing the executable report-generating program code.

19. The method of claim 1 and further comprising providing a tutorial.

20. The method of claim 1 and further comprising displaying a monitoring screen.

21. The method of claim 20 and further comprising displaying a time elapsed and a percent completed.

22. A system for producing report-generating program code, the system comprising:
interfacing means for obtaining an indication as to a source of data to be included in the report-generating program code and for obtaining formatting instructions for the data to be included in the report-generating program code;
retrieving means for retrieving the data from the source; and
producing means for producing the report-generating program code.

23. The system of claim 22 wherein the report-generating program code includes common business-orientated language code.

24. The system of claim 22 wherein the source of the data includes at least one of a database, a file, and a control card.

25. The system of claim 22 wherein the interfacing means obtains a standard query language select statement.

26. The system of claim 25 and further comprising executing means for executing the standard query language select statement to obtain the data from a database.

27. The system of claim 22 wherein the interfacing means obtains a name of a file including the data.

28. The system of claim 27 wherein the interfacing means obtains a format of the file.

29. The system of claim 27 wherein the retrieving means retrieves the data from the file.

30. The system of claim 22 and further comprising display means for displaying the data.

31. The system of claim 30 wherein the interfacing means obtains an indication as to a subset of the data to be included in a report generated by executing the report-generating program code.

32. The system of claim 22 wherein the interfacing means obtains report heading formatting instructions.

33. The system of claim 32 wherein the interfacing means obtains report heading formatting instructions including a variable.

34. The system of claim 33 wherein the interfacing means associates the variable with at least one of the data and a standard variable.

35. The system of claim 22 and further comprising storing means for storing the report-generating program code in a storage medium.

36. The system of claim 22 and further comprising modifying means for allowing a user to modify the report-generating program code.

37. The system of claim 22 and further comprising compiling means for generating executable report-generating program code.

38. The system of claim 37 and further comprising storing means for storing the executable report-generating program code in a storage medium.

39. The system of claim 37 and further comprising execution means for executing the executable report-generating program code.

40. The system of claim 22 and further comprising help means for providing a tutorial.

41. The system of claim 22 and further comprising display means for providing a monitoring screen.

42. The system of claim 41 and further comprising display means for displaying a time elapsed and a percent completed.

43. A computer readable medium containing instructions for producing report-generating program code, the instructions comprising:
obtaining an indication as to a source of data to be included in the report-generating program code;
retrieving data from the source;
obtaining formatting instructions for the data to be included in the report-generating program code; and
producing the report-generating program code based on the data and the formatting instructions.

44. The computer readable medium of claim 43 and further comprising producing the report-generating program code including common business-orientated language code.

45. The computer readable medium of claim 43 and further comprising obtaining an indication as to whether the source of the data includes at least one of a database, a file, and a control card.

46. The computer readable medium of claim 43 and further comprising obtaining a standard query language select statement.

47. The computer readable medium of claim 46 and further comprising executing the standard query language select statement to obtain the data from a database.

48. The computer readable medium of claim 43 and further comprising obtaining a name of a file including the data.

49. The computer readable medium of claim 48 and further comprising obtaining a format of the file.

50. The computer readable medium of claim 48 and further comprising retrieving the data from the file.

51. The computer readable medium of claim 43 and further comprising displaying the data.

52. The computer readable medium of claim 51 and further comprising obtaining an indication as to a subset of the data to be included in a report generated by executing the report-generating program code.

53. The computer readable medium of claim 43 and further comprising providing report heading formatting instructions.

54. The computer readable medium of claim 53 and further comprising providing report heading formatting instructions including a variable.

55. The computer readable medium of claim 54 and further comprising associating the variable with at least one of the data and a standard variable.

56. The computer readable medium of claim 43 and further comprising storing the report-generating program code in a storage medium.

57. The computer readable medium of claim 43 and further comprising allowing a user to modify the report-generating program code.

58. The computer readable medium of claim 43 and further comprising generating executable report-generating code from the report-generating program code.

59. The computer readable medium of claim 58 and further comprising storing the executable report-generating program code in a storage medium.

60. The computer readable medium of claim 58 and further comprising executing the executable report-generating program code.

61. The computer readable medium of claim 43 and further comprising providing a tutorial.

62. The computer readable medium of claim 43 and further comprising displaying a monitoring screen.

63. The computer readable medium of claim 62 and further comprising displaying a time elapsed and a percent completed.
